(19) United States
(12) Patent Application Publication
(10) Pub. No.: US 2021/0206095 A1
(43) Pub. Date: Jul. 8, 2021

(54) CLEANING PARTS

(71) Applicant: HEWLETT-PACKARD DEVELOPMENT COMPANY, L.P., Spring, TX (US)

(72) Inventor: Frank PERDICARO, Corvallis, OR (US)

(73) Assignee: HEWLETT-PACKARD DEVELOPMENT COMPANY, L.P., Spring, TX (US)

(21) Appl. No.: 16/075,916

(22) PCT Filed: Jul. 29, 2017
(86) PCT No.: PCT/US2017/044557

§ 371 Date: Aug. 6, 2018

(51) Int. Cl. B29C 64/35; B08B 3/10; B29C 71/00; B33Y 40/20

(52) U.S. Cl. CPC B29C 64/35; B08B 3/10; B29C 71/009; B33Y 40/20; B29C 71/0009

(57) ABSTRACT

In an example implementation, a method of cleaning parts includes placing the parts into a variable compression chamber, filling the chamber with a liquid, and forcing pressurized gas to dissolve into the liquid to form a gas-liquid solution. The method includes cycling the pressure within the chamber around a gas solubility pressure level to repeatedly bring gas molecules out of the solution as gas bubbles, and force the gas molecules to dissolve back into the solution.

### BACKGROUND

Additive manufacturing processes can produce three-dimensional (3D) parts by providing a layer-by-layer accumulation and solidification of build material patterned from digital models. In some examples, powdered build material such as powdered nylon can be processed using heat to cause melting and solidification of the material in selected regions of each layer. In some examples, the solidification of build material can be accomplished in other ways, such as through the use of binding agents or chemicals. The solidification of selected regions of build material can form 2D cross-sectional layers of the 3D object being produced, or printed.

### BRIEF DESCRIPTION OF THE DRAWINGS

Examples will now be described with reference to the accompanying drawings, in which:

FIG. 1 shows an example of a variable compression cleaning device for cleaning parts that have been manufactured by processes that can leave fine particles on the surfaces of the parts;

FIG. 2 shows an example of a variable compression cleaning device having an external particle filtration system;

FIG. 3 shows an example of a variable compression cleaning device during a cleaning process where the volume in the chamber is being increased;

FIG. 4 shows an example of a variable compression cleaning device in which molecules of gas from gas bubbles have formed a thin gaseous layer above the surface of a gas-liquid solution within a chamber;

FIG. 5 shows an example of a variable compression cleaning device during a cleaning process where the volume in the chamber is being decreased;

FIG. 6 shows an example of a variable compression cleaning device in which a variable compression cap mechanism is repeating a pressure cycling process;

FIG. 7 shows an example of a variable compression cleaning device with an external particle filtration system during the process of filtering fine particles from a gas-liquid solution;

FIGS. 8 and 9 show flow diagrams of example methods of cleaning parts in an example variable compression cleaning device.

Throughout the drawings, identical reference numbers designate similar, but not necessarily identical, elements.

### DETAILED DESCRIPTION

Additive manufacturing processes such as 3D printing can use different powdered build materials to produce parts or objects having a variety of different characteristics. The terms ‘part’ and ‘object’ and their variants may be used interchangeably throughout this description. The powdered build materials can comprise fine dust-like particles that help to produce sharp details in the manufactured parts. Examples of such additive manufacturing processes include Electron Beam Melting (EBM) that can use metal powders such as Titanium Alloys to manufacture dense and strong metal parts, Selective Laser Sintering (SLS) that can use metal, plastic, and ceramic powders to manufacture parts of varying strengths and densities, and 3D printing processes that can use a variety of different powdered build materials to manufacture parts with a range of strengths, densities and other properties.

In some examples, 3D printing processes can spread layers of powdered build material (e.g., nylon or other plastic) over a platform or print bed within a work area. A fusing agent can be selectively applied to each layer where the particles of powder material are to be fused together. Each layer in the work area can be exposed to a fusing energy to fuse together the particles of powder material where the fusing agent has been applied. The process can then be repeated, one layer at a time, until a part or parts have been formed within the work area.

After parts have been produced, post-manufacturing processing steps can be performed to finish the parts and put them in condition for sale and use. Such post-manufacturing steps can include, for example, passive or active cooling of the parts, removing the parts from a bin or “cake” of powder, and cleaning off excess powder or other debris that remains on the parts. In some examples, post-manufacturing steps intended to remove excess powder and debris may not be adequate to clean the fine powder dust particles from the outside and inside surfaces of the parts.

The difficulty of cleaning fine dust particles from parts is often increased in examples where parts have large interior volumes. In such cases, parts are often produced with internal support structures (e.g., honeycomb-like structures) instead of with solid interior volumes. Such internal structures help to minimize the internal mass of some parts while maintaining the strength of the parts. The smaller masses can also help parts cool faster and improve overall production speeds. However, while much of the solid internal volumes of such parts can be selectively eliminated during manufacturing, the result can be an increase in the amount of internal surface areas from the support structures and the unfilled or hollowed out areas within the parts that remain exposed to the outside or ambient environment. The exposed internal structures and hollow areas of such parts have greater surface areas from which to remove the fine dust particles during post-processing. Cleaning parts that have such larger internal surface areas increases the time and expense involved in getting the parts into a finished condition.

A variety of post-manufacturing methods currently used for cleaning such parts involve a hands-on approach to washing the parts. For example, parts can be cleaned using brushes, water, waterjets, and/or compressed air. Other methods for cleaning parts can include putting them in a dishwasher, vibrating them on a vibration table, combinations thereof, and so on. Most of these methods involve a hands-on, part-by-part cleaning, that can be time consuming and labor intensive.

Accordingly, example methods and devices described herein enable an inexpensive, fast, mostly hands-off, mechanical cleaning of parts that have fine particles remaining on their exterior and interior surfaces as a result of different manufacturing processes such as additive and other manufacturing processes. A variable compression cleaning device includes a chamber such as a tank or pot that can hold pressurized gas-liquid solutions. Parts to be cleaned can be placed into the chamber through an opening, and the chamber opening can then be closed. Depending on the parts being cleaned and the types of particles being cleaned from the parts, the chamber can then be filled with an appropriate gas-liquid solution. For example, for plastic parts that have fine particles of plastic powder to be cleaned from their surfaces, an appropriate gas-liquid solution can comprise a carbon dioxide (CO2) and water solution. Using a CO2-water solution as an example, the chamber can be filled with water and then pressurized with the CO2 at a low pressure, such as 25 PSI. Forcing CO2 into the water-filled chamber under pressure infuses the CO2 into the water and creates carbonated water, or CO2-water solution. In other examples, such as for metal parts that have fine particles of metal powder on their surfaces, an appropriate gas-liquid solution may comprise acetylene gas infused in liquid acetone. Thus, while a CO2-water solution is used throughout this description, other gas-liquid pairs may be appropriate solutions for use in a variable compression cleaning device.

The cleaning device also comprises a variable compression cap mechanism that can be used to close and seal the chamber, and to independently control both the pressure within the chamber as well as the rate of change of the pressure within the chamber. Thus, in some examples the variable compression cap mechanism can serve as a removable top or cover used to close and seal the opening in the chamber after parts have been placed inside. The variable compression cap mechanism is a cyclic device that repeatedly increases and decreases the pressure within the chamber around a gas solubility pressure level. The gas solubility pressure level is a pressure at which gas molecules in the chamber can transition from a gaseous state where they are out of the solution, to a dissolved state where they have been forced back into the solution. The solubility of a gas within a liquid can be better understood with reference to Henry's Law, which generally provides that the solubility of gas within a liquid is proportional to the pressure of the gas above the surface of the solution.

After the chamber has been closed and filled with the gas-liquid solution, the process of cleaning the enclosed parts can begin by using the variable compression cap mechanism to controllably increase the volume within the chamber. Increasing the volume of the chamber results in a decrease in the pressure within the chamber which causes CO2 to escape from the solution in the form of CO2 gas bubbles. The variable compression cap mechanism controls the rate of decrease of pressure within the chamber by controlling the speed at which it increases the volume of the chamber. This enables the variable compression cap mechanism to bring CO2 out of solution in a controlled manner that does not result in an explosion of gas that could be damaging to the parts within the chamber.

The formation of CO2 gas bubbles can occur at nucleation sites within the chamber. The nucleation sites beneficially include locations where the fine particles of powder and dust cling to the surfaces of the parts that have been placed within the chamber for cleaning. As CO2 gas bubbles continue to come out of the gas-liquid solution, they can rise toward the top of the chamber and above the surface of the solution. Bubbles that form at nucleation sites on surfaces of the parts can entrain the fine particles of powder and dust as they rise through the solution. As the bubbles rise, they can lift or carry the dust particles off of the parts and drop or release the particles into the solution. Bubbles that do not rise through the solution, but instead remain on the parts, can release particles into the solution when the bubbles are forced back into solution again, as noted below. In some examples, the particles can fall passively to the bottom of the chamber where they can be subsequently removed. In some examples, the particles may be colloidal, and/or they may have a positive and/or negative buoyancy. The solution may therefore contain particles throughout the volume of the chamber, from the bottom to the top. In some examples, therefore, the particles can be actively removed from the chamber by a filtration system that can continually pump the gas-liquid solution through a particle filter. Such a filtration system can be oriented toward different areas of the chamber to filter solution from throughout the chamber.

After a brief period of time during which CO2 gas has bubbled out of the gas-liquid solution, such as several seconds, the variable compression cap mechanism can then reverse the process by reducing the volume of the chamber in a controlled manner. The decrease in volume increases the pressure within the chamber and forces the CO2 gas back into the gas-liquid solution (i.e., the carbonated water). As the CO2 gas and gas bubbles dissolve back into the gas-liquid solution, there can be additional cleaning or removal of fine particles off of the surface areas of the parts in the chamber. For example, some bubbles that do not rise through the solution to the top of the solution, but instead remain on the surface of a part, can lift or carry the dust particles off of the parts and drop or release the particles into the solution when the bubbles are forced back into solution with the increase in pressure. The cycle of decreasing and increasing the pressure within the chamber around the gas solubility pressure level can be repeated numerous times to remove all or most of the fine particles of powder and dust from the parts in the chamber. While CO2 is being cycled back and forth between a gas and a gas-liquid solution, the gas-liquid solution in the chamber can be pumped through a filter to remove the small particles from the solution, as noted above.

In a particular example. a method of operating a cleaning device includes placing the parts into a variable compression chamber. The chamber can be closed and filled with a liquid. A gas under pressure can then be forced to dissolve into the liquid to form a gas-liquid solution. In some examples, the liquid initially put into the chamber can comprise a gas-liquid solution that can be further infused with gas after it is put into the chamber. For example, additional pressurized gas can be forced to dissolve into the gas-liquid solution until the liquid reaches a gas saturation point. The pressure within the chamber can then be cycled around a gas solubility pressure level to repeatedly bring gas molecules out of the solution as gas bubbles and force the gas molecules to dissolve back into the solution.

In another example, a variable compression cleaning device includes a variable compression chamber. The chamber includes an aperture to enable the insertion of parts to be cleaned, and the extraction of the parts after they are cleaned. The chamber includes a liquid input port to allow the chamber to be filled with a liquid. The chamber includes a gas inlet valve to enable inputting pressurized gas into the chamber to create a gas-liquid solution. The cleaning device includes a variable compression cap mechanism to seal the aperture closed, and to controllably cycle the pressure up and down within the chamber around a gas solubility pressure level to cause gas bubbles to repeatedly come out of the gas-liquid solution and infuse back into the gas-liquid solution. In some examples, the cleaning device includes a filtration system to circulate a gas-liquid solution through a filter to remove small particles from the solution.

In another example, a method of operating a cleaning device includes arranging the parts to be cleaned in a variable compression chamber such that hollowed interior portions of the parts are oriented upward toward the top of the chamber. The chamber can then be sealed closed with a variable compression cap mechanism. The chamber can then be filled with a gas-liquid solution. Filling the chamber includes filling it full so that there is no gap of air or other gas left between the solution and the cap mechanism. The method includes increasing and decreasing the volume within the chamber to repeatedly bring gas bubbles out of the solution and force gas from the gas bubbles to dissolve back into the solution. In some examples the method includes, during the increasing and decreasing the volume within the chamber, continually filtering the gas-liquid solution to remove fine particles from the solution that have been cleaned off of the parts and dropped into the solution by the gas bubbles.

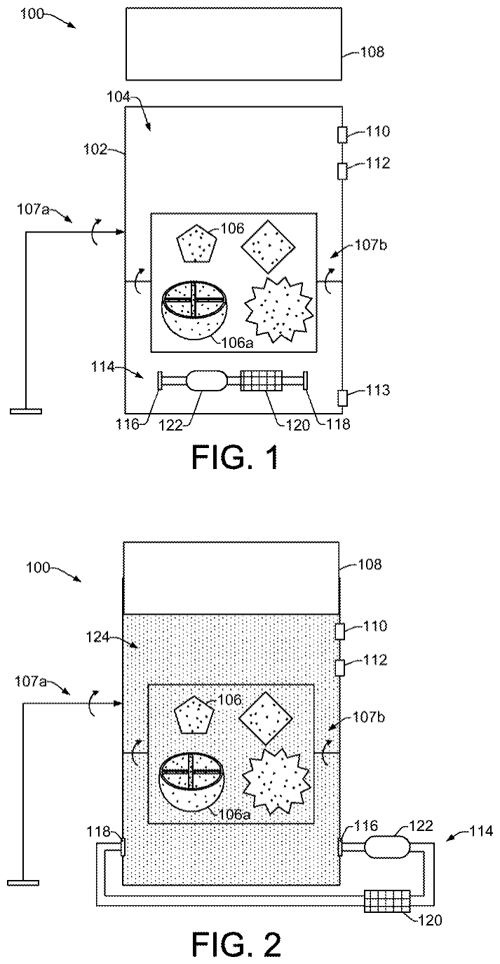

FIG. 1 shows an example of a variable compression cleaning device 100 for cleaning parts that have been manufactured by processes that can leave fine particles on the surfaces of the parts, such as powder dust and other debris. Parts manufactured in powder-based additive manufacturing processes such as some 3D printing processes are suitable examples of the types of parts that can be cleaned in the variable compression cleaning device 100. Such parts often have fine powder particles remaining on their surfaces that can be difficult to remove using a variety of other post-manufacturing cleaning processes. In some examples, a variable compression cleaning device can comprise and integral component of a 3D printer or other additive manufacturing device.

As shown in FIG. 1, a variable compression cleaning device 100 includes a variable compression chamber 102. The variable compression chamber 102 is capable of holding liquid and pressurized gas. In some examples the chamber 102 can comprise a metal cylinder. While the size of the chamber 102 may vary, in some examples the size of the chamber is on the order of a number of gallons, such as five to ten gallons. The chamber 102 has an opening 104 or aperture for receiving parts 106 that are to be cleaned in the chamber 102. In some examples the chamber 102 can include a parts rotating framework 107 (illustrated as 107a and 107b) for rotating parts 106. In different examples a framework 107 can comprise an external framework 107a for rotating the chamber 102 with the parts 106 inside, or it can comprise an internal framework 107b for rotating the parts 106 within the chamber 102. The chamber 102 includes a cap 108 or top that can cover the opening 104 and seal the chamber closed, for example, after parts have been placed in the chamber. In some examples the cap 108 comprises a cyclic variable compression cap mechanism 108. The chamber 102 additionally includes a liquid input port 110 to enable filling up the chamber with a liquid after parts have been placed in the chamber 102. The chamber 102 also includes a gas inlet valve 112 to enable the introduction of pressurized gas into the chamber. In some examples the chamber 102 can include a liquid draining port 113 to drain liquid solution from the chamber 102 after parts 106 have been cleaned in the chamber 102.

In some examples, the variable compression cleaning device 100 includes a particle filtration system 114. The particle filtration system 114 can filter the gas-liquid solution within the chamber to remove particles that have been cleaned from the parts 106 and have fallen into the solution. The particle filtration system 114 includes a filtration intake 116, a filtration output 118, a particle filter 120, and a fluidic pump 122 to pump the gas-liquid solution through the intake 116, through the particle filter 120, and out of the filtration output 122. In some examples the filtration intake 116 can be located toward the bottom of the chamber 102. In some examples the filtration intake 116 can be located at different levels within the chamber to draw in and filter the gas-liquid solution from different areas throughout the chamber. The location of the intake 116 can facilitate drawing in solution that has a higher concentration of particles, for example, due to the particles falling down through the solution by gravitational force and accumulating toward the bottom of the chamber 102. In some examples, the particle filtration system 114 can comprise an internal particle filtration system 114 that is self-contained within the chamber 102, as shown in FIG. 1. In some examples, as shown in FIG. 2, the particle filtration system 114 can comprise an external particle filtration system 114 that can circulate the gas-liquid solution out of the chamber, through the filter, and back into the chamber 102.

FIG. 2 shows a variable compression cleaning device 100 in which parts 106 have been placed into the chamber 102 for cleaning, and in which the chamber 102 has been filled with a gas-liquid solution 124. In some examples, parts 106, such as part 106a, can be arranged in a manner that faces their interior surface areas in an upward orientation, facing toward the variable compression cap mechanism 108. This orientation of the parts enables gas bubbles that form on dust particles within the interior surface areas of the parts to float upward through the gas-liquid solution. However, such orientation of parts is not necessary to enable gas bubbles to clean dust particles from the parts. As noted above, bubbles that do not rise through the solution to the top of the solution, but instead remain on the surface of a part, can lift or carry the dust particles off of the parts and drop or release the particles into the solution when the bubbles are forced back into solution with an increase in pressure within the chamber 102. In some examples, parts 106 can be arranged randomly within the chamber 102 having a parts rotating framework 107. Such a framework 107 (107a, 107b) enables parts 106 to be rotated either by rotating the entire chamber 102 with the parts 106 arranged within, or by rotating an internal framework 107b inside the chamber 102 that holds the parts 106. Rotating the parts 106 enables wetting of all of the surfaces of the parts which enables nucleation to occur on the surfaces of the parts.

After parts 106 have been arranged in the chamber 102, the chamber can be closed and sealed with the variable compression cap mechanism 108, and then filled with a liquid through the liquid input port 110. The chamber 102 can be filled completely with liquid so there is no gap between the variable compression cap mechanism 108 and the surface of the liquid. Having the chamber 102 fully filled with liquid provides optimal control when the variable compression cap mechanism 108 adjusts the chamber volume to cycle the pressure within the chamber around a gas solubility pressure level. After the chamber 102 is filled with liquid, a pressurized gas can be applied at the gas inlet valve 112 to force gas to dissolve into the liquid to form the gas-liquid solution 124. In some examples, the chamber 102 can be initially filled with a gas-liquid solution and additional gas can be dissolved into the solution through the gas inlet valve 112, For example, additional gas can be dissolved into the solution 124 until a gas saturation point is reached in the solution. In some examples, the chamber 102 can be filled with a single-component fluid that does not have a gas diffused into it. A single-component fluid may be developed to enable room temperature nucleation. A single-component fluid can be self-bubble forming at room temperature and ambient pressure. Such a single-component fluid can be developed to bubble vigorously at room temperature during a pressure drop within the chamber 102.

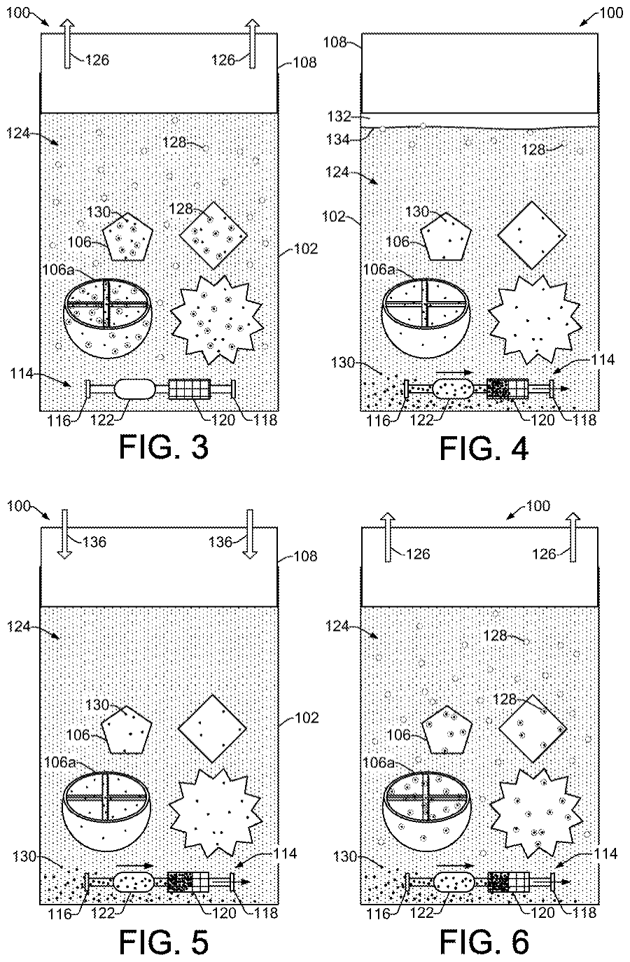

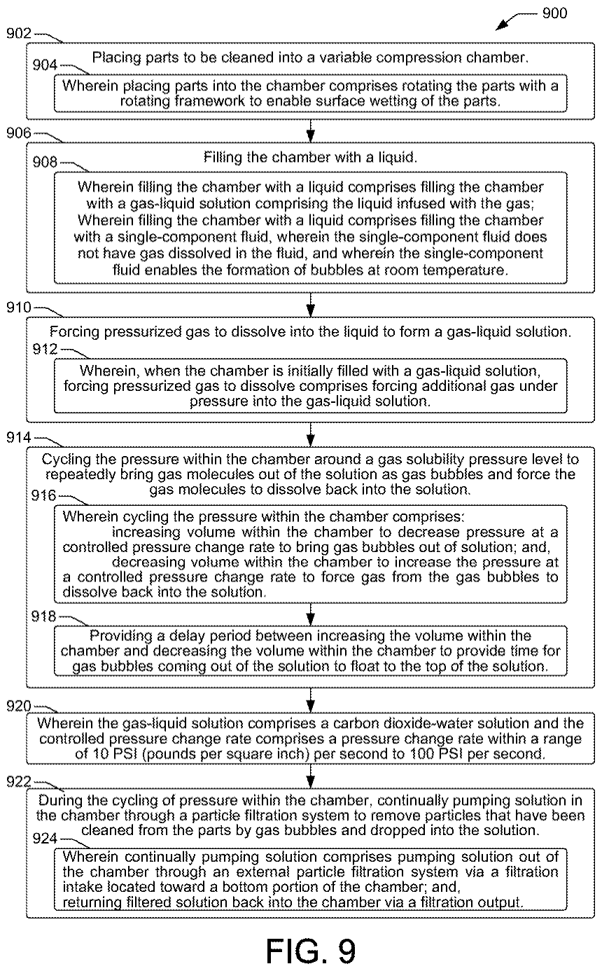

FIGS. 3-7 show an example variable compression cleaning device 100 at different stages during an example cleaning process. FIGS. 8 and 9 show flow diagrams of example methods 800 and 900 of cleaning parts in a variable compression cleaning device 100. Some of the operations of methods 800 and 900 correspond with details discussed above regarding the variable compression cleaning device 100 of FIGS. 1 and 2. Additional operations of methods 800 and 900 can be described with reference to the variable compression cleaning device 100 shown in FIGS. 3-7.

Referring to the flow diagrams of FIGS. 8 and 9, and generally to FIGS. 1-7, the methods 800 and 900 of operating a variable compression cleaning device 100 can begin with placing the parts to be cleaned within a variable compression chamber, as shown at blocks 802 and 902. In some examples, as shown at block 904 of method 900, placing the parts into the chamber can include rotating the parts with a rotating framework to enable surface wetting of the parts. In some examples, the variable compression cap mechanism 108 can be applied to seal the chamber 102 after the parts 106 have been placed inside.

As shown at blocks 804 and 906 of methods 800 and 900, respectively, the chamber 102 can be filled with a liquid. When the chamber 102 has been sealed, the liquid can be input through the liquid input port 110. The liquid can be input through port 110 until it completely fills the chamber 102 and immerses the parts 106. The liquid can fill the chamber 102 so that there is no air gap or other gas gap between the surface of the liquid and the surface of the variable compression cap mechanism 108, as shown generally in FIGS. 2 and 3, and 5-7. In some examples, as shown at block 908 of method 900, filling the chamber with a liquid can include filling the chamber with a gas-liquid solution comprising the liquid already infused with some of the gas. In some examples, filling the chamber with a liquid can include filling the chamber with a single-component fluid, wherein the single-component fluid does not have gas dissolved in the fluid, and wherein the single-component fluid enables the formation of bubbles at room temperature.

After liquid has been input into the chamber 102, a pressurized gas can then be forced to dissolve into the liquid as shown at blocks 806 and 910 of methods 800 and 900. The pressurized gas can be input through a gas inlet port 112 as shown in FIGS. 1 and 2. In some examples, the gas can be at a low pressure on the order of 25 PSI of pressure. In examples where the chamber 102 is initially filled with a gas-liquid solution, as just noted above, additional pressurized gas can be forced to dissolve into the gas-liquid solution as shown at block 912 of method 900. In some examples, pressurized gas can continue to be dissolved into the liquid until the liquid reaches a gas saturation level.

After the chamber 102 has been filled with a gas-liquid solution, the cleaning process can continue by cycling the pressure within the chamber up and down around a gas solubility pressure level, as shown generally at blocks 808 and 914 of methods 800 and 900, respectively. Cycling the pressure within the chamber around a gas solubility pressure level repeatedly brings gas molecules out of the solution as gas bubbles, and forces the gas molecules to dissolve back into the solution. An example process of cycling the pressure within the chamber is shown in FIGS. 3-7. In this example, as shown at block 916 of method 900, cycling the pressure within the chamber includes increasing the volume within the chamber to decrease the pressure at a controlled pressure change rate, followed by decreasing the volume within the chamber to increase the pressure at a controlled pressure change rate. Increasing the volume in the chamber so as to decrease the pressure at a controlled pressure change rate brings gas bubbles out of solution, and decreasing the volume in the chamber to increase the pressure at a controlled pressure change rate forces gas from the gas bubbles to dissolve back into the solution.

FIG. 3 shows an example variable compression cleaning device 100 during a cleaning process where the volume in the chamber 102 is being increased to decrease the pressure at a controlled pressure change rate. As shown in FIG. 3, the variable compression cap mechanism 108 can operate to increase the volume by moving in an upward or outward direction as indicated by upward arrows 126. As the volume increases, pressure is reduced in the chamber 102 and the gas-liquid solution 124 is pulled against by the variable compression cap mechanism 108 as it moves upward 126. The decrease in pressure causes gas bubbles 128 to escape from the solution 124 and rise toward the top of the chamber 102. The variable compression cap mechanism 108 controls the rate of decrease of pressure within the chamber by controlling the speed at which it increases the volume of the chamber. In some examples, where the gas-liquid solution 124 comprises a carbon dioxide-water solution, the controlled pressure change rate can comprise a pressure change rate within a range of about 10 PSI (pounds per square inch) per second to about 100 PSI per second, as shown at block 920 of method 900. Controlling the pressure change rate in this manner enables the variable compression cap mechanism 108 to bring gas bubbles 128 out of solution slowly enough that the bubbles do not result in an explosion of gas that could be damaging to the parts 106 within the chamber 102.

As noted above, gas bubbles 128 that come out of the gas-liquid solution 124 can form at nucleation sites within the chamber 102. Nucleation sites include locations where the fine particles 130 of powder and dust cling to the surfaces of the parts 106. As shown in FIG. 3, gas bubbles 128 that come out of the gas-liquid solution 124 tend to form on the fine particles 130 of powder and dust clinging to the surfaces of parts 106. As gas bubbles 128 continue to come out of the gas-liquid solution 124, they rise toward the top of the chamber 102 and can form a thin gaseous layer 132 (i.e., a layer of gas molecules) above the surface 134 of the gas-liquid solution 124, as shown in FIG. 4. Gas bubbles 128 that form on the fine particles 130 of powder and dust can entrain the particles as they rise through the solution. As the bubbles rise, they can lift or carry the fine particles 130 off of the parts 106 and drop or release the particles back into the solution 124. Thus, as shown in FIG. 4, fine particles 130 that have been lifted or cleaned off of the parts 106 can then drift down through the solution 124 toward the bottom of the chamber 102 under the force of gravity.

FIG. 5 shows an example of the variable compression cleaning device 100 during a cleaning process where the volume in the chamber 102 is being decreased in order to increase the pressure at a controlled pressure change rate. Referring again to the method 900 of FIG. 9, as shown at block 918, in some examples a delay period is provided between increasing the volume within the chamber and decreasing the volume within the chamber. The delay period can provide time for gas bubbles 128 coming out of the solution to mostly float to the top of the solution. In some examples, the delay period can comprise a number of seconds. In some examples a delay period can be within a range of one to five seconds. However, other lengths of delays are possible.

As shown in FIG. 5, the variable compression cap mechanism 108 can operate to decrease the volume by moving in a downward or inward direction as indicated by downward arrows 136. As the volume in the chamber 102 decreases, pressure in the chamber 102 increases, and the molecules of gas in the thin gaseous layer 132 above the surface 134 of the gas-liquid solution 124 (FIG. 4), as well as the molecules of gas in any of the remaining gas bubbles 128, dissolve back into the gas-liquid solution 124 under the force of the increasing pressure. As shown in FIG. 5, the gas that previously escaped from the gas-liquid solution 124, has been forced back into the solution 124.

As shown in FIG. 5, after decreasing the pressure in the chamber 102 to bring gas bubbles out of the solution 124, followed by increasing the pressure in the chamber 102 to force the gas back into solution, additional fine particles 130 can still remain on the parts 106. Accordingly, the variable compression cap mechanism 108 comprises a cyclical device that continues to cycle the pressure in the chamber up and down around the gas solubility pressure level of the gas-liquid solution to remove a substantial amount of the fine particles 130 from the parts 106. Thus, as shown in FIG. 6, the variable compression cap mechanism 108 begins to repeat the pressure cycling process by increasing the volume in the chamber 102 to reduce the pressure and cause gas bubbles 128 to escape again from the solution 124 and rise toward the top of the chamber 102.

Referring again to the method 900 in FIG. 9, as shown at block 922, during the cycling of pressure within the chamber, the gas-liquid solution 124 can be continually pumped through a particle filtration system 114. The particle filtration system 114 can remove the fine particles 130 from the solution 124 that are being continually cleaned off of the parts 106 and dropped back into the solution through the ongoing gas-bubbling process. As shown in FIGS. 4, 5, and 6, the particle filtration system 114 can be located within the chamber 102 where it can pump the gas-liquid solution 124 through an intake 116, through a particle filter 120, and out of a filtration output 118. In some examples it is beneficial to locate the intake 116 toward the bottom of the chamber 102 to facilitate drawing in gas-liquid solution 124 that has a higher concentration of fine particles 130 that have fallen down through the solution 124 and accumulated toward the bottom of the chamber 102. As shown in FIGS. 4, 5, and 6, the fine particles 130 can become trapped in the filter 120, resulting in a filtered or “clean” gas-liquid solution 124 being returned to the chamber 102.

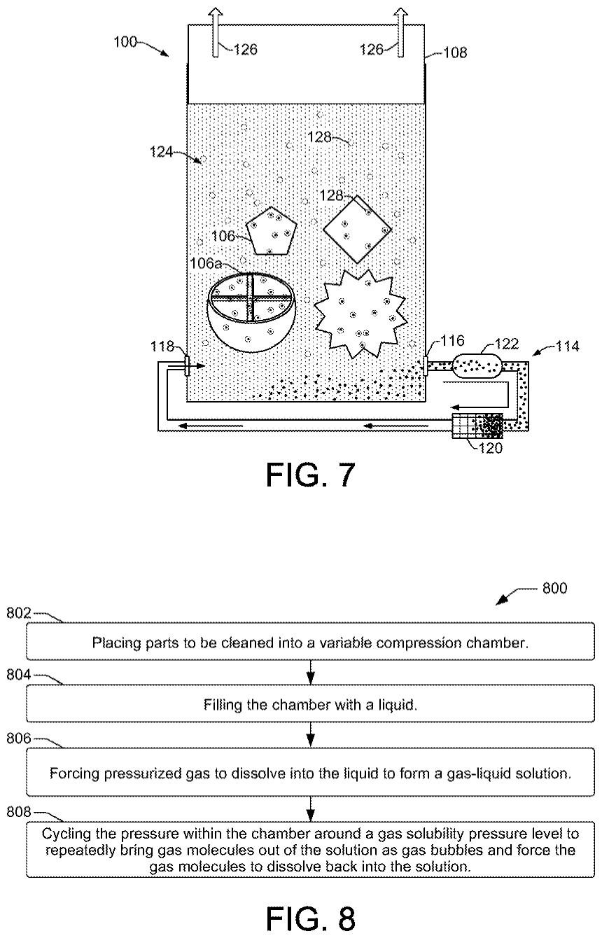

In some examples, as shown at block 924 of method 900, the gas-liquid solution 124 can be pumped out of the chamber and through an externally located particle filtration system 114. FIG. 7 shows an example of a variable compression cleaning device 100 comprising an external particle filtration system 114. In this example system, an intake 116 can again be located toward the bottom of the chamber 102 to facilitate drawing in gas-liquid solution 124 with a higher concentration of fine particles 130. The solution 124 can be pumped through an external particle filter 120 to remove the fine particles 130, and the filtered solution can be returned to the chamber 102 through a filter output 118. that have fallen down through the solution 124 and accumulated toward the bottom of the chamber 102.

After the variable compression cap mechanism 108 runs through a number of cleaning cycles, the gas-liquid solution 124 can be drained from the chamber 102 and the cleaned parts 106 can be removed.

What is claimed is:

1. A method of operating a cleaning device comprising:
placing parts to be cleaned into a variable compression chamber;
filling the chamber with a liquid;
forcing pressurized gas to dissolve into the liquid to form a gas-liquid solution;
cycling the pressure within the chamber around a gas solubility pressure level to repeatedly bring gas molecules out of the solution as gas bubbles and force the gas molecules to dissolve back into the solution.

2. A method as in claim 1, wherein cycling the pressure within the chamber comprises:
increasing volume within the chamber to decrease the pressure at a controlled pressure change rate to bring gas bubbles out of the solution; and,
decreasing the volume within the chamber to increase the pressure at a controlled pressure change rate to force gas from the gas bubbles to dissolve back into the solution.

3. A method as in claim 1, wherein placing parts to be cleaned into a variable compression chamber comprises rotating the parts with a rotating framework to enable surface wetting of the parts.

4. A method as in claim 2, further comprising providing a delay period between increasing the volume within the chamber and decreasing the volume within the chamber to provide time for gas bubbles coming out of the solution to float to the top of the solution. A method as in claim 2, wherein the gas-liquid solution comprises a carbon dioxide-water solution and the controlled pressure change rate comprises a pressure change rate within a range of about 2 PSI (pounds per square inch) per second to about 100 PSI per second.

6. A method as in claim 1, further comprising:
during the cycling of pressure within the chamber, continually pumping solution in the chamber through a particle filtration system to remove particles that have been cleaned from the parts by gas bubbles and dropped into the solution.

7. A method as in claim 6. wherein continually pumping solution in the chamber through a particle filtration system comprises:
pumping solution out of the chamber through an external particle filtration system via a filtration intake located toward a bottom portion of the chamber; and,
returning filtered solution back into the chamber via a filtration output.

8. A method as in claim 1, wherein:
filling the chamber with a liquid comprises filling the chamber with a gas-liquid solution comprising the liquid infused with the gas; and,
forcing additional gas under pressure into the gas-liquid solution.

9. A method as in claim 1, wherein:
filling the chamber with a liquid comprises filling the chamber with a single-component fluid, wherein the single-component fluid does not have gas dissolved in the fluid, and wherein the single-component fluid enables the formation of bubbles at room temperature.

10. A variable compression cleaning device comprising:
a variable compression chamber;
an aperture in the chamber to enable insertion and extraction of parts to be cleaned;
a liquid input port to enable inputting a liquid into the chamber;
a gas inlet valve to enable inputting pressurized gas into the chamber to create a gas-liquid solution; and,
a variable compression cap mechanism to seal the aperture and to controllably cycle pressure up and down within the chamber to cause gas bubbles to repeatedly come out of the gas-liquid solution and infuse back into the gas-liquid solution.

11. A variable compression cleaning device as in claim 10, further comprising a particle filtration system to circulate the gas-liquid solution through a filter.

12. A variable compression cleaning device as in claim 10, further comprising a framework to enable rotation of the parts in the chamber.

13. A variable compression cleaning device as in claim 10 integrated within a 3D printer.

14. A method of operating a cleaning device comprising:
arranging parts to be cleaned in a variable compression chamber, wherein the arranging comprises orienting hollowed interior portions of the parts upward toward the top of the chamber;
sealing the chamber closed with a variable compression cap mechanism;
filling the chamber with a gas-liquid solution such that there is no gap between the solution and the cap mechanism;
rotating the parts with a rotational framework in the chamber to wet surfaces of the parts; and,
increasing and decreasing the volume within the chamber to repeatedly bring gas bubbles out of the solution and force gas from the gas bubbles to dissolve back into the solution.

15. A method as in claim 14, further comprising, during the increasing and decreasing the volume within the chamber, continually filtering the gas-liquid solution to remove fine particles from the solution that have been cleaned off of the parts and dropped into the solution by the gas bubbles.
